(19) United States
(12) Patent Application Publication
(10) Pub. No.: US 2008/0176640 A1
(43) Pub. Date: Jul. 24, 2008

(54) GAME SYSTEM CAPABLE OF ACCEPTING PLAYER TO PARTICIPATE ANY TIME IN ONE OF PLURALITY OF GAMES

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/935,735

(22) Filed: Nov. 6, 2007

Related U.S. Application Data
(60) Provisional application No. 60/881,462, filed on Jan. 22, 2007.

(51) Int. Cl. A63F 13/00; A63F 9/24

(52) U.S. Cl. 463/25; 463/31

(57) ABSTRACT

A game system according to the present invention includes a plurality of client terminals, each of which having a BET switch which enables a player playing a game to place a BET; and a controller programmed to execute the following processing of; (a) controlling a plurality of games, in each of which a unit game is repeatedly executed, and the each unit game includes a period for accepting the BET placed through the BET switch provided in each of the client terminals; and (b) controlling to determine the BET accepting period for the respective games such that, during a period when two or more of the games are executed at the same time, BETs for at least one of the games are accepted any time during this time period.

### CROSS-REFERENCE TO RELATED APPLICATIONS

This application claims benefit of priority based on U.S. Provisional Patent Application No. 60/881,462 filed on Jan. 22, 2007. The contents of this application are incorporated herein by reference in their entirety.

### BACKGROUND OF THE INVENTION

1. Field of the Invention

The present invention relates to a game system where a BET can be inputted.

2. Discussion of the Background

There conventionally exist game systems which include a plurality of client terminals and execute a game in common among a plurality of players. Among such game systems, there are game systems that include a plurality of client terminals and a common screen, and execute a slot machine game or a roulette game displayed to the common screen, as disclosed in US 2005/0059474-A1, US 2005/0282618-A1, and US 2005/0218590-A1. In such a game, a player playing the game at each client terminal can place a BET on a result of the game displayed to the common screen. For example, when a slot machine game is displayed to the common screen, a BET can be placed on a line number, and when a roulette game is displayed, a straight BET or a combination BET can be placed on a layout of the roulette.

It is an object of the present invention to provide a game system capable of reducing the waiting time in participating a multiplayer-entry-type game, and having a new entertainment property.

The contents of US 2005/0059474-A1, US 2005/0282618-A1, and US 2005/0218590-A1 are incorporated herein by reference in their entirety.

### SUMMARY OF THE INVENTION

A first aspect of the present invention provides a game system having the following configuration.

Namely, the above-mentioned game system includes a plurality of client terminals, each of which having a BET switch which enables a player playing a game to place a BET. Further, the above-mentioned game system includes a controller programmed to execute the processing of; (a) controlling a plurality of games, in each of which a unit game is repeatedly executed, and the each unit game includes a period for accepting a BET placed through the above-mentioned BET switch provided in each of the above-mentioned client terminals; and (b) controlling to determine the BET accepting period for the above-mentioned respective games such that, during a period when two or more the above-mentioned games are executed at the same time, the BETs for at least one of the above-mentioned games are accepted any time during this period.

A second aspect of the present invention provides a game system having the following configuration.

Namely, the above-mentioned game system includes a plurality of client terminals each of which having a BET switch which enables a player playing a game to place a BET. Further, the above-mentioned game system includes a controller programmed to execute the following processing of; (a) controlling a plurality of games, each of which including a period for accepting the BET placed through the above-mentioned BET switch provided in each of the above-mentioned client terminals; and (b) controlling to start acceptance of BETs for at least one of the above-mentioned games, until the end of accepting the BET in all games in which the BET is being accepted, out of the above-mentioned games, out of the above-mentioned games.

A third aspect of the present invention provides a game system having the following configuration.

Namely, the above-mentioned game system includes a display capable of displaying images. Further, the above-mentioned game system includes a plurality of client terminals, each of which having a BET switch capable of placing a BET and being placed at a position which enables a player playing a game to view the above-mentioned display. Further, the above-mentioned game system includes a controller programmed to execute the following processing of; (a) controlling a plurality of games, each of which including a period for accepting a BET placed through the above-mentioned BET switch provided in each of the above-mentioned client terminals; (b) controlling the game system for displaying images relating to the above-mentioned plurality of games to the above-mentioned display; and (c) controlling to start acceptance of BETs for at least one of the above-mentioned games, until the end of accepting the BET in all games in which the BET is being accepted, out of the above-mentioned games.

A fourth aspect of the present invention includes a game system with the following configuration.

Namely, the above-mentioned game system includes a plurality of client terminals, each of which having a BET switch which enables a player playing a game to place a BET. Further, the above-mentioned game system includes a controller programmed to execute the following processing of; (a) controlling a plurality of games, each of which including a period for accepting a BET placed through the above-mentioned BET switch provided in each of the above-mentioned client terminals; (b) controlling to start acceptance of BETs for at least one of the above-mentioned games, until the end of accepting the BET in all games in which the BET is being accepted, out of the above-mentioned games; and (c) controlling to start accepting the BET for a game other than a game in which the BET is being accepted, when the number of client terminals at which the BET has been placed for above-mentioned game in which the BET is being accepted, out of above-mentioned client terminals, becomes equal to or larger than a predetermined number.

### BRIEF DESCRIPTION OF THE DRAWINGS

FIG. 1 is a flow chart showing a subroutine of control-device-side processing executed by the control device provided in a game system according to one embodiment of the present invention;

FIG. 2 is a view illustrating game cycles and BET accepting periods, according to the present embodiment.

FIG. 3 is a perspective view schematically showing an external structure of the game system according to one embodiment of the present invention;

FIG. 4 is a perspective view schematically showing an external structure of a station;

FIG. 5 is a view for illustrating winning lines;

FIG. 6 is a view showing one example of symbol arrays;

FIG. 7 is a view showing one example of an image displayed to the liquid crystal display;

FIG. 8 is a block diagram showing an internal structure of the control device;

FIG. 9 is a block diagram showing an internal structure of a station;

FIG. 10 is a flow chart illustrating processing executed in a control device for changing BET accepting period.

FIG. 11 is a flow chart illustrating a subroutine of a game processing.

FIG. 12 is a view showing a possibility for establishment of each symbol combination and the number of payouts; and

FIG. 13 is a flowchart showing a subroutine of a station-side processing executed in a station.

### DESCRIPTION OF THE EMBODIMENTS

With reference to the drawings, an embodiment of the present invention will be described.

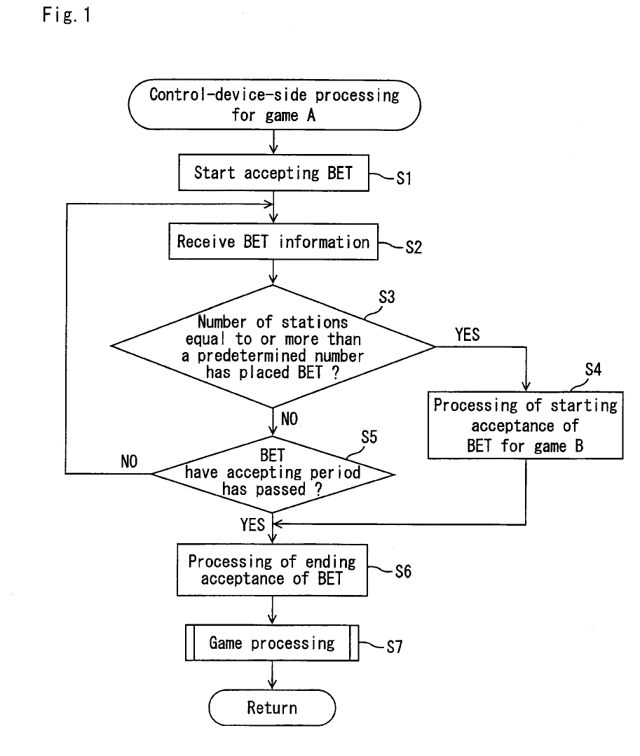

FIG. 1 is a flow chart illustrating a control-device-side process executed by a control device included in a game system according to an embodiment of the present invention.

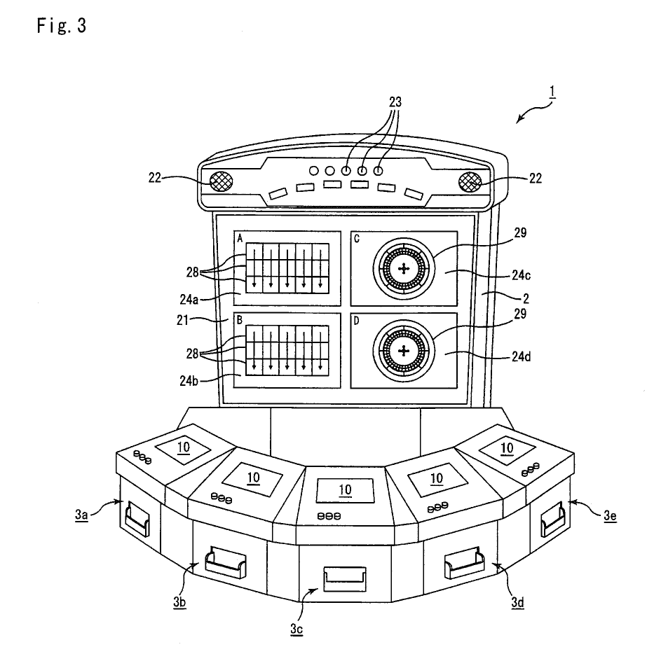

A game system 1 (see FIG. 3) executes four games, which are a game A, a game B, a game C and a game D.

In the present embodiment, there will be described a case where a plurality of games are executed, in each of which a single type of unit games is uninterruptedly repeated a plurality of times. In the present embodiment, “a unit game” refers to a game, described later, which starts upon accepting a BET and ends upon ending the game processing (see FIG. 1).

The game A and the game B are slot machine games, while the game C and the game D are roulette games. The game system 1 is controlled so as to start a BET accepting period for the game B at the end of a BET accepting period for the game A, to start a BET accepting period for the game C at the end of the BET accepting period for the game B, to start a BET accepting period for the game D at the end of the BET accepting period for the game C, and to start the BET accepting period for the game A again at the end of the BET accepting period for the game D, as will be described later.

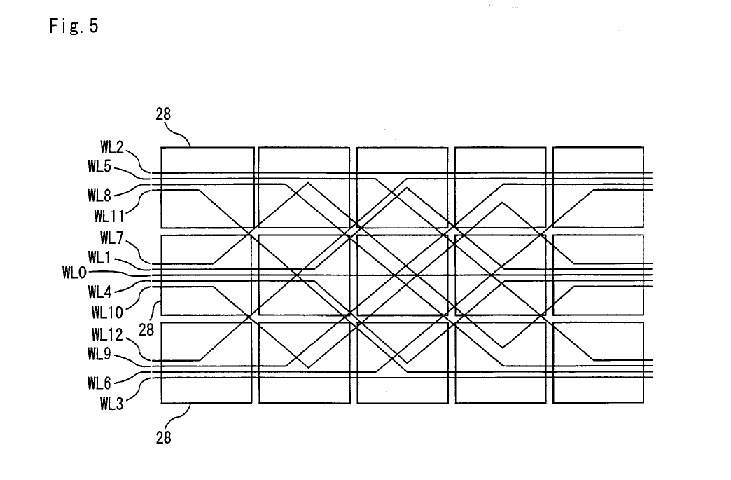

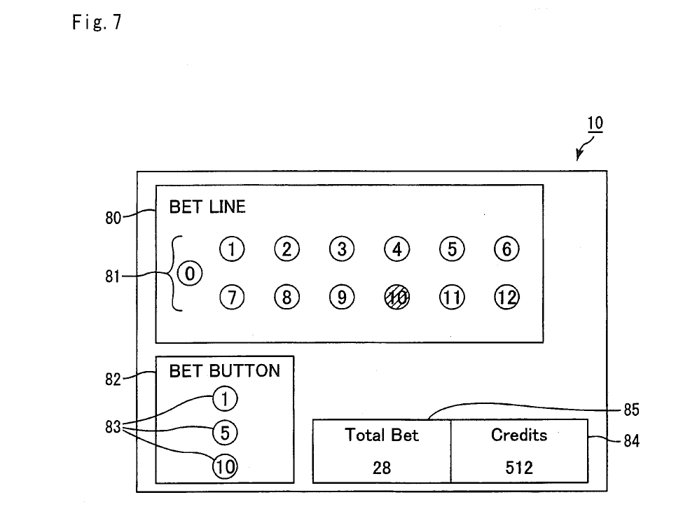

The game system 1 includes a main monitor 2 (see FIG. 3) for displaying images corresponding to the respective games. A game-A image display portion 24a, which is provided at an upper left portion of the front display 21, displays an image corresponding to the game A (a slot machine game), namely 15 display blocks 28 in five columns and three rows, in each of which a single symbol is arranged. Further, in the game-A image display portion 24a, 13 winning lines WL0 to WL12 are set so as to pass over all the columns (see FIG. 5). A game-B image display portion 24b, which is provided at a lower left portion of the front display 21, displays an image corresponding to the game B (a slot machine game), which is similar to the image displayed to the game-A image display portion 24a. Further, a game-C image display portion 24c which is provided at an upper right portion of the front display 21 and a game-D image display portion 24d which is provided at a lower right portion of the front display 21 display roulette images 29 as images corresponding to the game C and the game D (roulette games) respectively. During the BET accepting period for the game A, a player can operate a BET line select button 81 (see FIG. 7) to select a winning line on which a BET is to be placed, and can operate a number-of-BETs input button 83 (FIG. 7) to input the number of BETs on the selected winning line WL. In the main monitor 2, when the symbols are stop-displayed after scrolling, when the same symbols are arranged on the winning line WL on which the BET has been placed (when any of the predetermined symbol combinations has been established), coins corresponding to the symbol combination and the number of BETs are paid out to the station 3 operated by the player.

The processing executed by a control device provided in the game system 1 according to one embodiment of the present invention, in executing the game A, is described in the following.

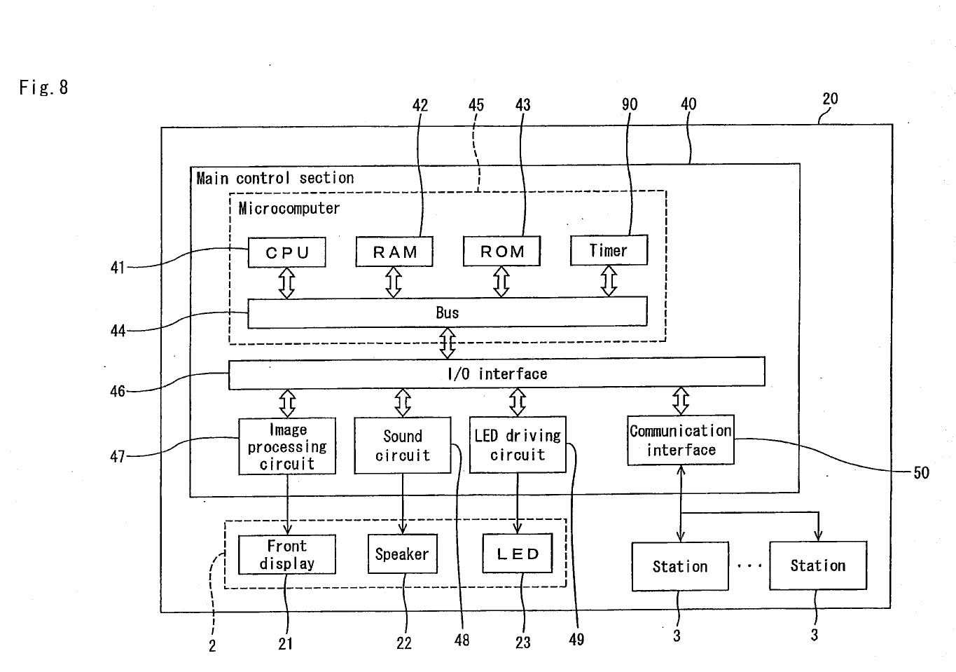

First, in step S1, a CPU 41 (see FIG. 8) of a control device 20 provided in the game system 1 starts accepting a BET for the game A. In this processing, the CPU 41 transmits a signal (hereinafter also referred to as BET start signal) for making each of the stations 3 start accepting an input of the BET. The BET for the game A can be inputted at each of the stations 3 where this signal has been received. At this time, the CPU 41 starts measuring time by means of a timer 90.

Next, in step S2, the CPU 41 receives BET information indicating that the BET has been placed and the contents of the BET, from the stations 3 at which the BET has been placed for the game A. In this processing, the CPU 41 stores the received BET information in a RAM 42 (see FIG. 8).

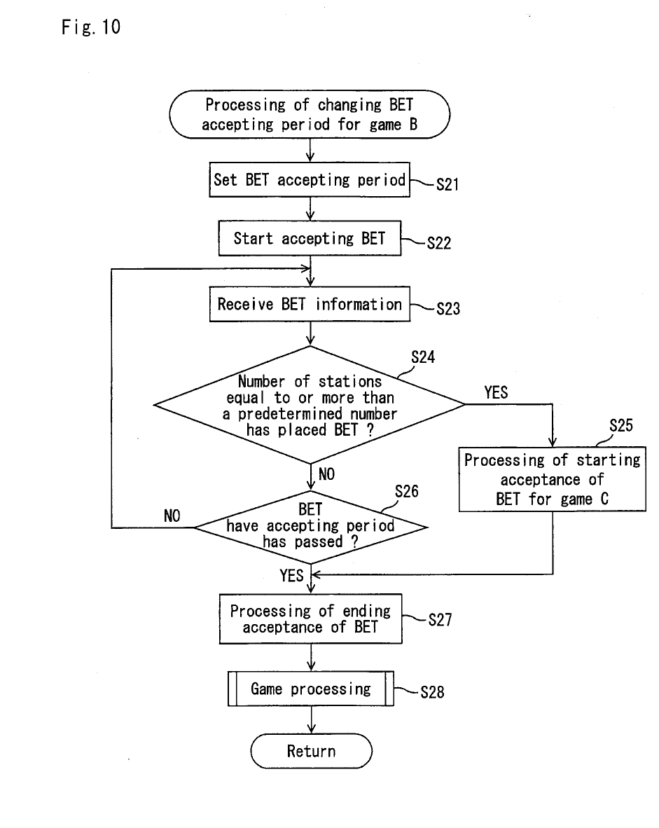

Next, in step S3, the CPU 41 determines whether or not to have received the BET information from the number of stations 3 equal to or larger than a predetermined number (3, in the present embodiment). When it is determined that the CPU 41 has received the BET information from the number of stations 3 equal to or more than the predetermined number, the CPU 41 executes processing for starting acceptance of a BET for the game B, in step S4. At this time, for the game B, the CPU 41 executes processing for changing the BET accepting period and starting acceptance of a BET for the game B. The processing for changing the BET accepting period will be described in detail later with reference to FIG. 10.

After executing processing in step S4, the CPU 41 waits for the end of the BET accepting period and shifts the processing to step S6.

In step S3, when it is determined that the CPU 41 has not received the BET information from the number of stations 3 equal to or more than the predetermined number, the CPU 41 determines whether or not the BET accepting period (30 seconds, in the present embodiment) has elapsed, in step S5. When the CPU 41 determines that the BET accepting period has not elapsed, the processing is returned to step S2.

When the CPU 41 determines in step S5 that the BET accepting period has elapsed, the CPU 41 executes processing for ending acceptance of the BET for the game A, in step S6. In this processing, the CPU 41 transmits, to the each station 3, a signal for making each of the stations 3 end accepting an input of the BET (hereinafter, referred to as BET end signal). In the case where the number of stations 3 at which a BET for the game A has been placed has not reached a predetermined number, a BET accepting period for the game B is started, upon executing this processing.

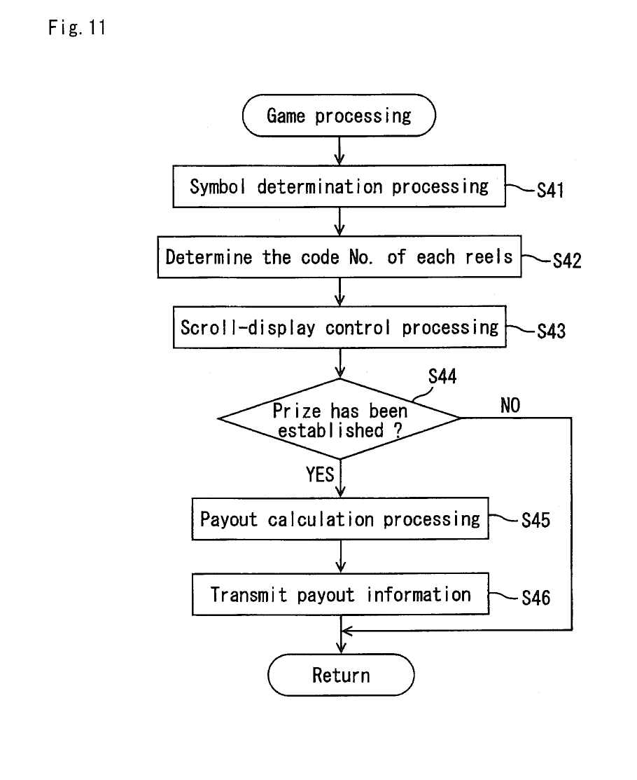

Next, in step S7, the CPU 41 executes game processing. This processing is processing for performing scrolling display of the symbols and calculation of a payout, which will be described later in detail with reference to FIG. 11.

After the execution of the processing in step S7, this control-device-side processing ends.

The control-device-side processing is also executed for the game B, the game C and the game D. The each processing for these games is the same processing as the above-mentioned control-device-side processing for the game A and is not described in detail herein. Here, in the control-device-side processing for the game B, the processing in step S4 (processing of starting acceptance of BET for game B) illustrated in FIG. 1 is changed to processing of starting acceptance of a BET for the game C.

In the control-device-side processing for the game C and the control-device-side processing for the game D, the processing in step S4 illustrated in FIG. 1 is changed to processing of starting acceptance of a BET for the game D and processing of starting acceptance of a BET for the game A, respectively, and the game processing in step S7 is changed to the processing relating to roulette games.

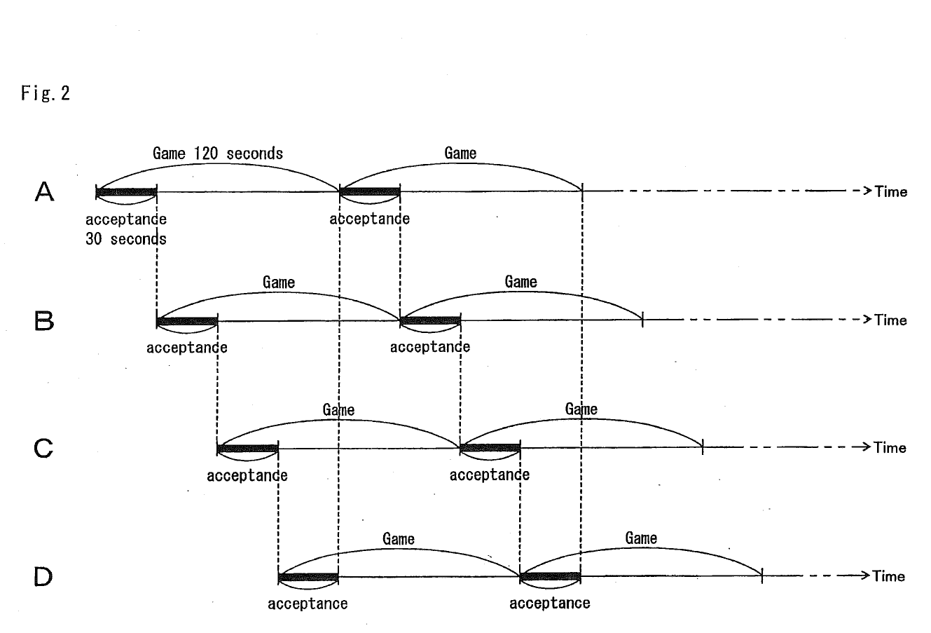

FIG. 2 is a view illustrating the cycles of games and BET accepting periods, according to the present embodiment.

In the present embodiment, the cycles of the games A to D are all 120 seconds. In the present invention, “the game cycle” refers to the length of a unit game including a BET accepting period. Namely, in the present embodiment, a unit game is a game corresponding to a single cycle (120 seconds). Further, the BET accepting period is for 30 seconds from the start of a unit game.

In the present embodiment, data on the game cycle, the BET accepting period and the like is pre-stored in a ROM 43 (see FIG. 8), and the CPU 41 determines the game cycle, the BET accepting period and the like, based on the data.

As illustrated in FIG. 2, at the end of a BET accepting period of 30 seconds for the game A, a BET accepting period for the game B is started. Further, after 30 seconds thereafter, a BET accepting period for the game C is started. Further, after 30 seconds thereafter, a BET accepting period for the game D is started. Further, at the end of the BET accepting period for the game D, 120 seconds has elapsed since the start of the game A and, therefore, a unit game of the game A has ended and a BET accepting period for the game A is started again. As described above, a BET is uninterruptedly accepted, in the order of the game A, the game B, the game C, the game D and the game A and, therefore, a BET is accepted any time for any of the games.

As illustrated in FIG. 1, when the number of stations 3 at which a BET for one of the games has been placed reaches a predetermined number, a BET accepting period for the next game is started. For example, when the number of stations 3 at which a BET for the game A has been placed reaches the predetermined number after 20 seconds from the start of a BET accepting for the game A, the BET accepting period for the game B is started at the time. Namely, the BET accepting period for the game B is started earlier by 10 seconds than a preset time point. In this case, as will be described in detail with reference to FIG. 10, the BET accepting period for the game B is changed to a time period (40 seconds) longer by 10 seconds than a preset time period. Since the period from the end of the BET accepting period for the game B to the end of the game B is not changed from the preset period (90 seconds), the time point at which the game B ends is not changed from the preset time point.

When the number of stations 3 at which a BET for the game B has placed becomes equal to or more than the predetermined number during the BET accepting period for the game B, when the number of stations 3 at which a BET for the game C has been placed becomes equal to or more than the predetermined number during the BET accepting period for the game C, and when the number of stations 3 at which a BET for the game D has been placed becomes equal to or more than the predetermined number during the BET accepting period for the game D, the same processing as the above-mentioned processing is executed respectively.

Next, the game system 1 according to the present embodiment is described.

FIG. 3 is a perspective view schematically showing an external structure of the game system according to one embodiment of the present invention.

As shown in FIG. 3, the game system 1 is comprised of the control device 20 having the main monitor 2 (see FIG. 8) and five stations 3 (stations 3a to 3e). The station 3 corresponds to the client terminal in the present invention.

On the center portion of the main monitor 2, there is provided the front display 21, in which there are provided the game-A image display portion 24a for displaying an image corresponding to the game A, the game-B image display portion 24b for displaying an image corresponding to the game B, the game-C image display portion 24c for displaying an image corresponding to the game C, and the game-D image display portion 24d for displaying an image corresponding to the game D. On the game-A image display portion 24a and the game-B image display portion 24b, 15 display blocks 28 in 5 columns and 3 rows are displayed and a single symbol is arranged in each display blocks 28. Further, roulette images 29 are displayed on the game-C image display portion 24c and the game-D image display portion 24d. Further, on the upper side of the main monitor 2, there is provided speakers 22 that output music and an effective sound along with the progress of a game and LEDs 23 which are lighted in a variety of renditions.

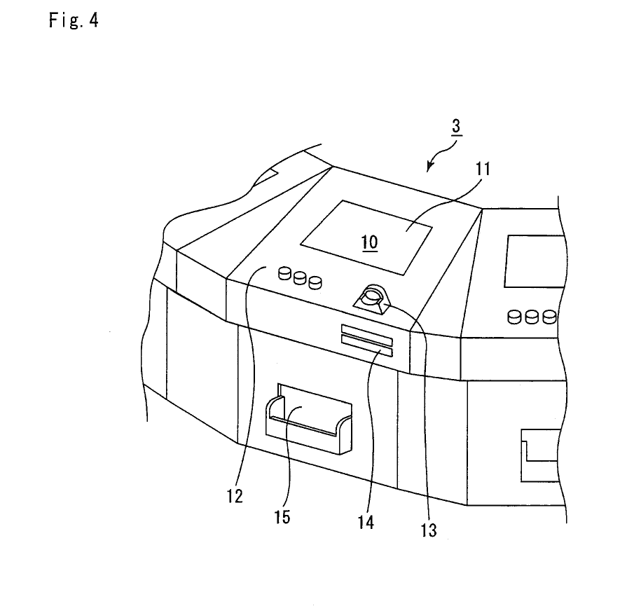

FIG. 4 is a perspective view schematically showing an external structure of the station provided in the game system shown in FIG. 3.

As shown in FIG. 4, at the center of the upper surface of the station 3, there is provided a liquid crystal display 10 for displaying later-described images regarding operations (see FIG. 7) and the like. Further, on the upper surface of the liquid crystal display 10, there is provided a touch panel 11 for inputting a direction such as a BET. The touch panel 11 corresponds to the BET switch in the present invention.

Operation buttons 12 for conducting a payout operation and a coin insertion slot 13 into which a coin or a medal is inserted are provided toward the front of the liquid crystal display 10.

A bill insertion slot 14 into which a bill is inserted is provided at the right end upper portion of the front of the station 3. Below the bill insertion slot 14, a coin payout exit 15 is provided for paying out coins or medals corresponding to the accumulated credits.

FIG. 5 is a view for illustrating the winning lines in slot machine games (the game A and the game B).

As shown in FIG. 5, the winning lines WL0 to WL12 are set so as to pass over any of the display blocks 28 along each column. In the present embodiment, 13 winning lines WL are set.

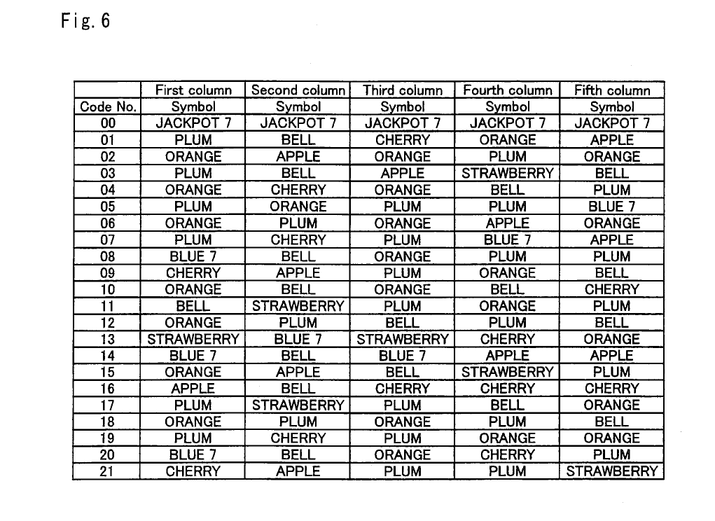

FIG. 6 is a view showing one example of symbol arrays in slot machine games (the game A and the game B).

As shown in FIG. 6, in each of the display blocks 28, an array of a total of 22 symbols, each of which has one of code numbers “00” to “21”, is arranged or scrolled. Each of the symbol arrays is constituted of a combination of the symbols “JACKPOT 7”, “BLUE 7”, “BELL”, “CHERRY”, “STRAWBERRY”, “PLUM”, “ORANGE”, and “APPLE”.

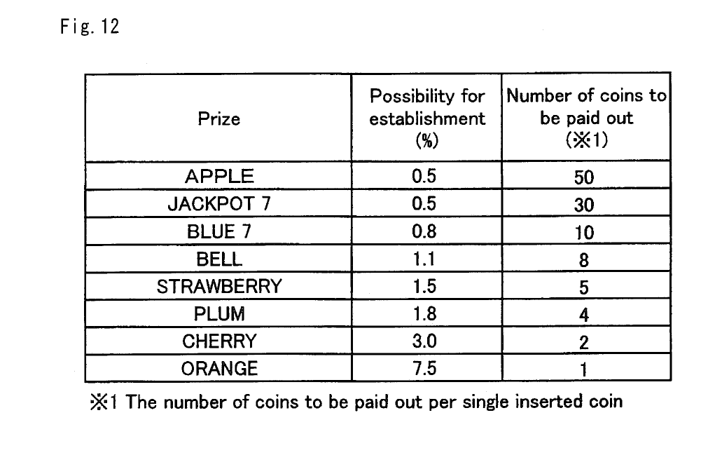

When five symbols of any one of “JACKPOT 7”, “BLUE 7”, “BELL”, “CHERRY”, “STRAWBERRY”, “PLUM”, “ORANGE”, and “APPLE” are arranged on any of the winning lines WL, the predetermined number of coins are paid out (see FIG. 12).

On timing to start scrolling of the symbols (e.g. fifteen seconds after the symbols along all the columns are stop-displayed in a previous unit game), all the symbols are scrolled downwardly from above. The symbols are arranged after a lapse of predetermined time. At this time, when a predetermined symbol combination is established, the player can receive a payout of the predetermined number of coins (see FIG. 11).

FIG. 7 is a view showing one example of an image displayed to the liquid crystal display when a BET is placed in slot machine games (the game A and the game B).

As shown in FIG. 7, at the upper portion of the liquid crystal display 10, there is provided a BET line select section 80 for selecting a winning line WL on which a BET is to be placed. In the BET line select section 80, BET line select buttons 81 are displayed for selecting the winning line WL on which the BET is to be placed. The player can operate the BET line select buttons 81 via the touch panel 11 to select the winning line WL on which the BET is to be placed. In FIG. 7, the color of the BET line select button 81 corresponding to the winning line WL12 is different from the color of the other BET line select buttons 81, indicating that the BET line select button 81 corresponding to the winning line WL12 has been operated.

On the lower left side with respect to the BET line select section 80, there is provided a BET button display section 82. BET buttons 83 for inputting the number of BETs are displayed to the BET button display section 82. The player can operate the BET buttons 83 via the touch panel 11 to input the number of BETs on the selected winning line WL.

On the right side with respect to the BET button display section 82, there is provided a number-of-BETs display section 85 for displaying the number of coins placed for the BET. FIG. 7 shows that a BET of 28 coins has been placed on the winning line WL10. In the case of inputting the BET of 28 coins, the player may operate the BET button 83 “10” twice, the BET button 83 “5” once and the BET button 83 “1” three times.

On the right side with respect to the number-of-BETs display section 85, there is provided a number-of-credits display section 84. FIG. 7 indicates that 512 coins have been credited.

FIG. 8 is a block diagram showing an internal structure of the control device provided in the game system shown in FIG. 3.

As shown in FIG. 8, a main control section 40 provided in the control device 20 is comprised of a microcomputer 45 as the core, which basically includes the CPU 41, a RAM 42, a ROM 43, the timer 90, and a bus 44 for transferring data mutually among these devices. The main control section 40 corresponds to the controller in the present invention.

In the ROM 43, a variety of programs for executing processing necessary in controlling the control device 20, data tables such as a payout table, and the like, are stored. The data tables include a table that defines corresponding relationships between combinations of the symbols to be arranged on the winning lines WL and the number of coins to be paid out corresponding to respective combinations and a table about a game cycle, a BET accepting period and the like. Specific relationships between the combinations and the number of payouts are described later with reference to FIG. 12. The RAM 42 is a memory in which a variety of data computed in the CPU 41 are temporarily stored. Further, the timer 90 measures the time.

Further, the CPU 41 is connected via an I/O interface 46 to an image processing circuit 47, a sound circuit 48, a LED driving circuit 49 and a communication interface 50.

The image processing circuit 47 is connected with the front display 21 comprising the main monitor 2. The sound circuit 48 is connected with the speakers 22 comprising the main monitor 2. The LED driving circuit 49 is connected with the LEDs 23 comprising the main monitor 2. Five stations 3 are connected to the communication interface 50. The front display 21 corresponds to the display in the present invention.

The CPU 41 makes a game progress based upon a game program stored in the ROM 43 and a variety of signals received from the stations 3, displays an image to the front display 21 according to progress of the game, outputs sound from the speakers 22, and turns the LEDs 23 on. Further, the CPU 41 transmits to each of the stations 3 a variety of signals such as the BET start signal, the BET end signal and the like, according to progress of the game.

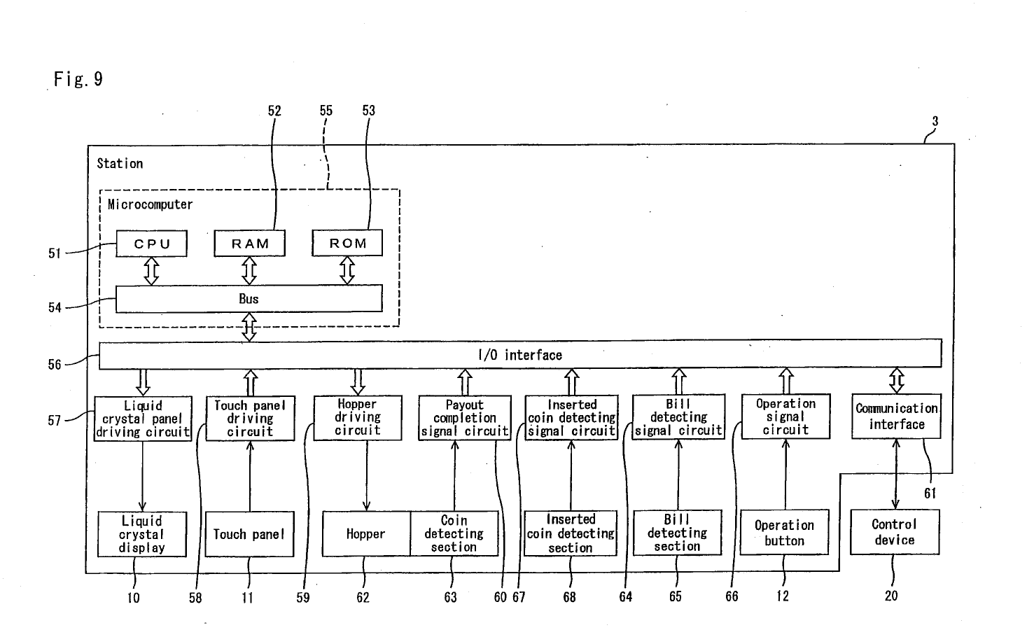

FIG. 9 is a block diagram showing an internal structure of the station provided in the game system shown in FIG. 3.

As shown in FIG. 9, the station 3 is comprised of a microcomputer 55 as a core, which basically includes a CPU 51, a RAM 52, a ROM 53, and a bus 54 for transferring data mutually among these devices.

In the ROM 53, a variety of programs, a data table and the like for executing processing necessary in controlling the stations 3 are stored. Further, the RAM 52 temporarily stores the number of credits currently accumulated in the stations 3 and a variety of data computed in the CPU 51.

Moreover, the CPU 51 is connected via an I/O interface 56 to a liquid crystal panel driving circuit 57, a touch panel driving circuit 58, a hopper driving circuit 59, a payout completion signal circuit 60, an inserted coin detecting signal circuit 67, a bill detecting signal circuit 64, an operation signal circuit 66 and a communication interface 61.

The liquid crystal display 10 is connected to the liquid crystal panel driving circuit 57. The touch panel 11 is connected to the touch panel driving circuit 58. A hopper 62 is connected to the hopper driving circuit 59. A coin detecting section 63 is connected to the payout completion signal circuit 60. An inserted coin detecting section 68 is connected to the inserted coin detecting signal circuit 67. A bill detecting section 65 is connected to the bill detecting signal circuit 64. The operation buttons 12 are connected to the operation signal circuit 66.

The hopper 62 is provided inside the station 3, and pays out coins from the coin payout exit 15 based upon a control signal outputted from the CPU 51.

The coin detecting section 63 is provided inside the coin payout exit 15, and transmits a signal to the CPU 51 upon detecting that a predetermined number of coins have been paid out from the coin payout exit 15.

The inserted coin detecting section 68 detects the amount of coins upon detection of the coins inserted from the coin insertion slot 13, and transmits a detecting signal indicating the detected amount to the CPU 51. The detected coins counted regarding a predetermined amount as one credit are stored into the RAM 52.

The bill detecting section 65 detects an amount of bills when the bills are accepted, and transmits a detecting signal indicating the detected amount to the CPU 51. The detected bills counted regarding a predetermined amount as one credit are stored into the RAM 52.

The operation buttons 12 are buttons for conducting a payout operation when a payout of coins is determined.

Next, processing executed in the control device 20 and the stations 3 are described. There has been already described, with reference to FIG. 1, the processing executed in the control device 20 when the number of stations 3 at which a BET for a game in which acceptance of the BET has been previously started does not reach the predetermined number. Therefore, description of this processing is omitted here.

FIG. 10 is a flow chart illustrating processing, executed by the control device 20, for changing the BET accepting period for the game B. This processing is executed when the number of stations 3 at which a BET has been placed for the game A becomes equal to or more than the predetermined number.

At first, in step S21, the CPU 41 sets a new BET accepting period. More specifically, the CPU 41 adds, to the pre-set BET accepting period (30 seconds) as the BET accepting period for the game B, the remaining BET accepting period at the time when the CPU 41 determines that BETs for the game A have been placed at the number of stations 3 equal to or more than the predetermined number.

Next, in step S22, the CPU 41 starts accepting a BET for the game B. In this processing, the CPU 41 transmits the BET start signal for making each of the stations 3 start accepting an input of the BET. The BET for the game B can be inputted at each of the stations 3 where this signal has been received. At this time, the CPU 41 starts measuring time by means of the timer 90.

Next, in step S23, the CPU 41 receives BET information from stations 3 at which the BET has been placed for the game B. In this processing, the CPU 41 stores the received BET information in the RAM 42.

Next, in step S24, the CPU 41 determines whether or not it has received the BET information from the number of stations 3 equal to or more than a predetermined number (3, in the present embodiment). When the CPU 41 determines that it has received the BET information from the number of stations 3 equal to or more than the predetermined number, the CPU 41 executes processing for starting acceptance of a BET for the game C, in step S25. At this time, the CPU 41 executes processing for changing the BET accepting period for the game C and starting acceptance of the BET for the game C. After executing the processing in step S25, the CPU 41 waits for the end of the BET accepting period and shifts the processing to step S27.

When the CPU 41 determines, in step S24, that it has not received the BET information from the number of stations 3 equal to or more than the predetermined number, the CPU 41 determines whether or not the new BET accepting period set in step S21 has elapsed, in step S26. When the CPU 41 determines that the BET accepting period has not elapsed, the CPU 41 returns the processing to step S23.

When the CPU 41 determines, in step S26, that the BET accepting period has elapsed, the CPU 41 executes processing for ending acceptance of the BET for the game B, in step S27. In this processing, the CPU 41 transmits the BET end signal to the each station 3. When the number of stations 3 at which the BET for the game B has been placed has not reached the predetermined number, the BET accepting period for the game C is started upon executing this processing.

Next, in step S28, the CPU 41 executes game processing. This processing is processing for displaying scrolling of the symbols and calculating a payout, which will be described later in detail with reference to FIG. 11.

After executing the processing in step S28, the CPU 41 ends this processing for changing the BET accepting period.

The processing for changing the BET accepting period is also executed for the game A, the game C and the game D, and the each processing for the game A, the game C and the game D is the same processing as the above-mentioned processing for changing the BET accepting period for the game B, therefore, description of the processing is omitted here. Further, in the processing for changing the BET accepting period for the game A, the processing in step S25 illustrated in FIG. 10 (processing of starting acceptance of a BET for game C) is changed to processing of starting acceptance of a BET for the game B. Further, in the processing for changing the BET accepting period for the game C and the processing for the changing the BET accepting period for the game D, the processing in step S25 illustrated in FIG. 10 is changed to processing of starting acceptance of a BET for game D and processing of start acceptance of a BET for game A, respectively, and the game processing in step S28 is changed to the processing relating to roulette games.

FIG. 11 is a flow chart illustrating a subroutine of the game processing which is executed in step S7 in FIG. 1 and in step S28 in FIG. 10.

First, the CPU 41 executes a program for random number generation included in a game program, to select a random number corresponding to each of the symbol columns, out of the numbers falling in a numerical range of 0 to 255 (step S41). In the present embodiment, a case of generating a random number on a program (a case of using a so-called software random number) is described. However, in the present invention, a random number generator may be provided and the random number may then be extracted from the random number generator (a so-called hardware random number may be used).

Next, the CPU 41 determines the code Nos. of the respective symbol columns (see FIG. 6) based upon five selected random numbers (step S42). The respective code Nos. of each of the symbol columns correspond to the respective code Nos. of stop-displayed symbols on the winning line WL0 on each of the columns. The CPU 41 determines the code No. of each symbol column to determine a symbol combination. For example, when the CPU 41 determines the code Nos. of the respective symbol columns as “00”, “00”, “00”, “00”, this means that the CPU 41 determines “JACKPOT 7” as the symbol combination.

Next, the CPU 41 executes scroll-display control processing (step S43). This processing is processing for starting scroll-display of the symbols and then stopping the scroll-display in the respective display blocks 28, such that a combination of the symbols corresponding to the prize determined in step S42 is stop-displayed on a winning line WL.

Next, in step S44, the CPU 41 determines whether or not a prize has been established, based on the result determined in step S42. When the CPU 41 determines that no prize has been established, the CPU 41 ends the present subroutine.

On the other hand, when the CPU 41 determines that a prize has been established, the CPU 41 executes payout calculation processing in step S45. Namely, the CPU 41 calculates a payout to be offered, based on the established prize and the BET information from the each station 3.

Next, in step S46, the CPU 41 transmits, to the each station 3, information about the payout calculated in step S45 (hereinafter, referred to as payout information).

After executing the processing in step S46, the CPU 41 ends the present subroutine.

Hereinafter, there will be described symbol combinations in the slot machine games according to the present embodiment.

FIG. 12 is a view showing a possibility for establishment of each symbol combination and the number of payouts.

When five “APPLE” symbols are arranged on a winning line WL, 50 coins are paid out per inserted coin. Further, when five “JACKPOT 7” symbols are arranged on a winning line WL, 30 coins are paid out per inserted coin. Similarly, when five of any one of the symbols “BLUE 7”, “BELL”, “STRAWBERRY”, “PLUM”, “CHERRY”, and “ORANGE” are arranged on a winning line WL, the number of coins corresponding to each of the combinations is paid out.

Next, the processing to be executed in the station 3 is described.

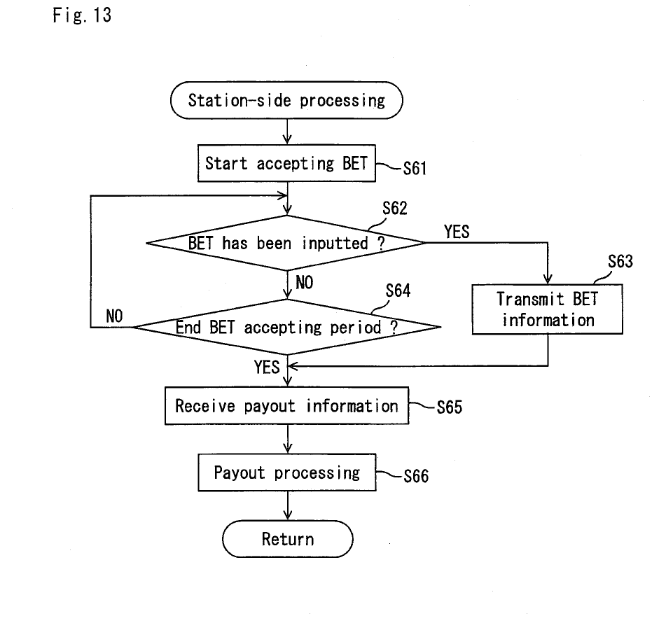

FIG. 13 is a flowchart showing a subroutine of a station-side processing executed in the station. There will be described a case where slot machine games are executed.

At first, in step S61, the CPU 51 included in the station 3 starts accepting a BET, on receiving the BET starting signal from the control device 20. At this time, the CPU 51 displays an image illustrated in FIG. 7 to the liquid crystal display 10.

Next, in step S62, the CPU 51 determines whether or not a BET has been inputted via the touch panel 11. In this processing, the CPU 51 determines whether or not the BET line select button 81 and the BET buttons 83 (see FIG. 7) have been operated via the touch panel 11.

Upon determining that no BET has been inputted (step S62: NO), the CPU 51 determines whether or not to end accepting the BET (step S64). In this processing, upon receiving a BET end signal from the control device 20, the CPU 51 determines to end accepting the BET. An input of the BET is considered to be accepted when the BET is inputted during a period from the start of accepting the BET in step S61 until the end of accepting the BET in step S64.

When determining not to end accepting the BET, the CPU 51 returns the processing to step S62. On the other hand, when determining to end accepting the BET, the CPU 51 shifts the processing to step S65.

In step S62, when determining that the BET has been inputted, the CPU 51 transmits the BET information showing that the BET has been placed and contents of the BET, to the control device 20 (step S63). The contents of the BET include the number of the winning line WL to which the BET is subject to and the number of BETs. After the processing of step S63, the processing is shifts to step S65.

In step S65, the CPU 51 receives the payout information from the control device 20.

Next, in step S66, the CPU 51 executes payout processing. More specifically, the CPU 51 stores the payout information received in step S65 in the RAM 52. Then, when the operation button 12 is operated, coins are paid out based on the payout information. After executing the process in step S66, the CPU 51 ends the present subroutine.

As described above, the game system 1 according to the present embodiment includes the front display 21 (display) capable of displaying images. Further, the game system 1 includes the touch panels 11 (BET switches) through which a BET is placed and also includes the plurality of stations 3 (client terminals) placed at positions which enable players playing games to view the front display 21. Further, the game system 1 includes a main control portion 40 (controller) programmed to execute the processing of; (a) controlling a plurality of games having a period for accepting a BET placed through the touch panel 11 included in each of the stations 3; (b) controlling for displaying images relating to the plurality of games to the front display 21; (c) controlling for starting acceptance of BETs for at least a single game until the end of accepting BETs in all games in which a BET is being accepted; and (d) controlling for, when the number of stations 3 equal to or more than a predetermined number have placed a BET for a game in which a BET is being accepted, starting acceptance of a BET for a game other than this game.

In the present embodiment, when the number of stations 3 at which a BET for a single game has placed does not reach the predetermined number, the BET accepting periods of all the games become equal to one another. However, in the present invention, the BET accepting periods for respective games may be different from one another, as long as the BET accepting periods are set so as to accept uninterruptedly, namely as long as the BET accepting periods are set such that acceptance of BETs in at least a single game is started until the end of accepting BETs in all games in which a BET is being accepted.

Further, although in the present embodiment, when the number of stations 3 at which a BET for a single game has placed does not reach the predetermined number, the cycles of all the games are made equal to one another, the respective games may have different game cycles in the present invention. In this case, the cycles of the respective games can be set such that after the start of accepting a BET for a single game, at least a single unit game ends until the end of continuous acceptance of a BET (which may be acceptance of BETs for a plurality of games). In the case of setting the game cycles as described above, acceptance of a BET for a unit game which has already ended may be started again, until the end of continuous acceptance of the BET.

Further, while, in the present embodiment, at the end of a BET accepting period for a single game, a BET accepting period for another game is started so that a BET is uninterruptedly accepted, the timing of starting a BET accepting period for each game is not limited thereto, as long as the BET accepting periods for respective games are continuous, in the present invention. For example, BET accepting periods of a plurality of games may be overlapped such that 5 seconds before the end of a BET accepting period for a single game, a BET accepting period for another game is started.

Further, while, in the present embodiment, when the number of stations 3 at which a BET for a single game has placed becomes equal to or more than a predetermined number, a BET accepting period for a different game is changed (extended) to provide a period during which the BET accepting periods of a plurality of games are overlapped, in the present invention, only the timing of starting a different game may be changed to provide a period during which BET accepting periods of a plurality of games are overlapped, without changing the BET accepting period and the game cycle.

While, in the present embodiment, there has been described the case where four games are executed by a single game system, the number of games which are executed by a single game system can be properly set as required, provided that the number of games is more than one.

Although the case of playing the slot machine games and the roulette games has been described in the present embodiment, the game to be executed in the present invention is not limited to this example, as long as a game which has a period for accepting a BET on a predetermined subject, e.g. a roulette game, a bingo game, and card games such as poker, Black Jack and a tarot card game.

While, in the present embodiment, there has been described a game system 1 which executes a plurality of games using a single main monitor 2, the game system is not limited thereto, in the present invention. For example, the game system according to the present invention may be a game system which is constituted by a plurality of gaming machines including a main monitor and a client terminal and a management server which controls these gaming machines, such that the each gaming machine can execute one or more games.

Although the case of including a plurality of stations 3 has been described in the present embodiment, a station (client terminal) may not be provided in the present invention so long as it is possible to accept an input of a BET.

While, in the present embodiment, there has been described the case where a plurality of players play games while visually identifying the common main monitor 2, the game system may not include a main monitor, in the present invention. In this case, for example, a plurality of client terminals may be placed around a plurality of roulette machines to enable players to play games while visually identifying the roulette machines.

Although the embodiment according to the present invention has been described above, the description presents only some of the specific examples, and does not particularly limit the present invention, and specific constitutions of each means and the like can be properly changed in terms of design. Further, the effects described in the embodiment of the present invention are only examples of the most preferable effects generated from the present invention and the effect to be caused by the present invention is not limited to those described in the embodiment of the present invention.

In the above detailed description, for a better and easier understanding of the present invention, the description is mainly made on the featuring aspects of the present invention. The present invention is not limited to the embodiments in the above detailed description, and may be applied to other varieties of embodiments. Also, it is to be understood that the phraseology and terminology employed in this specification are used to precisely describe the present invention, and should not be regarded as limiting the interpretation of the present invention. Moreover, based on the conception described in the present specification, those skilled in the art will readily come up with other configuration, systems and methods and the like included in the conception of the present invention. As such, it should be elucidated that the claims include such equivalent constitutions insofar as they do not depart from the spirit and scope of the present invention. Further, the purpose of the foregoing abstract is to enable the U.S. Patent and Trademark Office and general public institutions, and those skilled in the art and the like who are not familiar with patent or legal terminology, to quickly determine the nature and essence of the technical disclosure of this application with a simple search. Therefore, the abstract is not intended to define the scope of the present invention, which should be measured by the description of the claims. Furthermore, for fully understanding the purposes and the featuring effects of the present invention, desirably, the present invention is interpreted with reference to published publications and the like.

The detailed descriptions aforementioned may be presented in terms of processing executed by a computer. Those descriptions and terms set forth in the above are described for the purpose that those skilled in the art understand the present invention in a most effective way. In the present specification, each step used for leading one result should be understood a self-consistent procedure. In each step, sending and receiving, or recording or the like of electrical or magnetic signals are performed. Although, such signals are expressed in bit, value, symbol, character, term, number and the like in processing of each step; however, it is important to note that those expressions are used simply for convenience of explanation. Moreover, processing in each step is in some cases described using expressions in common with those for human activities, but processing described in the present specification is in principle performed by various apparatuses. Furthermore, some other constitutions required for carrying out the respective step are considered to be self-explanatory from the aforementioned descriptions.

What is claimed as new and desired to be secured by Letters Patent of the United States is:

1. A game system comprising:
a plurality of client terminals, each of which having a BET switch which enables a player playing a game to place a BET; and
a controller programmed so as to execute the following processing of;
(a) controlling a plurality of games, in each of which a unit game is repeatedly executed, and the each unit game includes a period for accepting a BET placed through said BET switch provided in each of said client terminals; and
(b) controlling to determine the BET accepting period for each of said games such that, during a period when two or more said games are executed at the same time, BETs for at least one of said games are accepted any time during this period.

2. A game system comprising:
a plurality of client terminals, each of which having a BET switch which enables a player playing a game to place a BET; and
a controller programmed so as to execute the following processing of;
(a) controlling a plurality of games, each of which including a period for accepting a BET placed through said BET switch provided in each of said client terminals; and
(b) controlling to start acceptance of BETs for at least one of said games, until the end of accepting the BET in all games in which the BET is being accepted, out of said games.

3. A game system comprising:
a display capable of displaying images;
a plurality of client terminals, each of which having a BET switch capable of placing a BET and being placed at a position which enables a player playing a game to view said display; and
a controller programmed so as to execute the following processing of;
(a) controlling a plurality of games, each of which including a period for accepting a BET placed through said BET switch provided in each of said client terminals;
(b) controlling to display images relating to said plurality of games to said display; and
(c) controlling to start acceptance of BETs for at least one of said games, until the end of accepting the BET in all games in which the BET is being accepted, out of said games.

4. A game system comprising:
a plurality of client terminals, each of which having a BET switch which enables a player playing a game to place a BET; and
a controller programmed so as to execute the following processing of;
(a) controlling a plurality of games, each of which including a period for accepting a BET placed through said BET switch provided in each of said client terminals;
(b) controlling to start acceptance of BETs for at least one of said games, until the end of accepting the BET in all games in which the BET is being accepted, out of said games; and
(c) controlling to start acceptance of a BET for a game other than a game in which a BET is being accepted, when the number of client terminals at which the BET has been placed for said game in which the BET is being accepted, out of said client terminals, becomes equal to or larger than a predetermined number.
